(19) United States
(12) Patent Application Publication
(10) Pub. No.: US 2008/0159732 A1
(43) Pub. Date: Jul. 3, 2008

(54) Positioning device

(76) Inventors: Stuart Young, Lisle, IL (US); Timothy Anderson, Prospect Heights, IL (US); Raymond L. Bratton, Addison, IL (US); Daniel Mark Mullin, Colorado Springs, CO (US)

Correspondence Address: Kevin D. Erickson;Pauley Petersen & Erickson, Suite 365, 2800 West Higgins Road, Hoffman Estates, IL, 60169, US

(21) Appl. No.: 11/648,186

(22) Filed: Dec. 29, 2006

(51) Int. Cl. G03B 17/00

(52) U.S. Cl. 396/427

(57) ABSTRACT

A positioning device, such as a pan & tilt device, includes a housing having a drivetrain and one or more removable mounts positioned on the housing. An accessory, such as a camera, may be positioned on or in the removable mount and a release joins the removable mount to the housing for “plug and play” adaptation of the accessory to the positioning device.

### BACKGROUND OF THE INVENTION

1. Field of the Invention

This invention relates to a positioning device, such as a pan & tilt device, having a housing with plug and play capabilities.

2. Description of Related Art

Positioning devices, such as pan & tilt devices and those described herein, are commonly housings that support one or more components. The positioning device enables such components to move in a predetermined and/or selectable path. The positioning device according to this invention is preferably a pan & tilt device used in connection with a component that requires both a panning and tilting motion, including cameras, thermal imaging equipment, lasers, weapon systems, antennas and/or any such similar device. Pan & tilt devices are commonly used in connection with cameras and similar applications requiring precise positioning around multiple axes of rotation; monitoring systems for security, control, interaction, measurement and other applications requiring active or passive monitoring of a particular environment.

Past positioning devices are generally sold in connection with one or more particular components that are connected with respect to the positioning device, both electronically and mechanically so as to make replacement of the particular component(s) difficult or impossible.

### SUMMARY OF THE INVENTION

The positioning device according to a preferred embodiment of this invention may be a pan & tilt device for accommodating one or more cameras, imaging equipment, weapon systems, measuring system, surveillance system or any other similar component known to those having ordinary skill in the art.

The positioning device according to this invention includes a housing having mechanical internals including a drivetrain. One or more removable mounts are preferably positioned relative to the housing to permit panning and tilting of a camera or similar accessory positioned on or within each removable mount.

According to a preferred embodiment of this invention, each removable mount is connected with the housing with a release to permit both an electrical and mechanical communication between the accessory and the housing controller. As such, replacement accessories may be swapped into the housing and immediately be recognized by the positioning device thus permitting uninterrupted operation of the positioning device following a swap-out of one or more removable mounts.

### BRIEF DESCRIPTION OF THE DRAWINGS

The above-mentioned and other features and objects of this invention will be better understood from the following detailed description taken in conjunction with the drawings wherein:

FIG. 1 is a left side perspective view of a pan & tilt device according to one preferred embodiment of this invention;

FIG. 2 is a right side view of a removable mount using in connection with the pan & tilt device shown in FIG. 1;

FIG. 3 is an exploded view of a removable mount with camera for use in connection with the pan & tilt device shown in FIG. 1;

FIG. 4 is a bottom view of the pan & tilt device shown in FIG. 1;

FIG. 5 is a cross-section front view of the pan & tilt device shown in FIG. 1, taken along section 5-5 shown in FIG. 4;

FIG. 6 is a top perspective view of a portion of a drivetrain, specifically a tilt drive, of the pan & tilt device shown in FIG. 1;

FIG. 7 is a side view of the portion of the tilt drive of the pan & tilt device shown in FIG. 6;

FIG. 8 is a bottom view of the portion of the tilt drive of the pan & tilt device shown in FIG. 6 and a side view of the housing of the pan & tilt device shown in FIG. 1, following removal of the removable mount shown in FIG. 2;

FIG. 9 is an exploded side perspective view of a slip ring assembly according to one preferred embodiment of this invention;

FIG. 10 is a front view of a sensor assembly for use with a pan & tilt device according to one preferred embodiment of this invention;

FIG. 11 is a cross-sectional side view of the sensor assembly of FIG. 10 taken along Section 11-11; and

FIG. 12 is an exploded top perspective view of the sensor assembly shown in FIG. 10.

### DESCRIPTION OF PREFERRED EMBODIMENTS

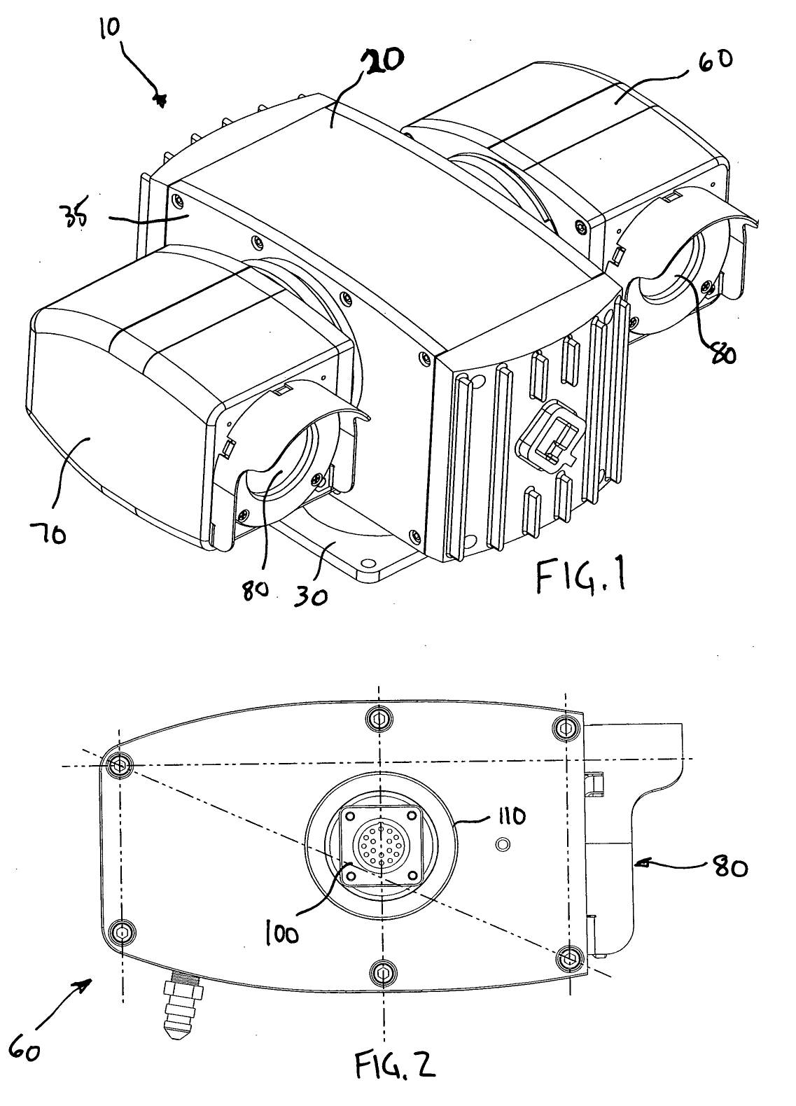

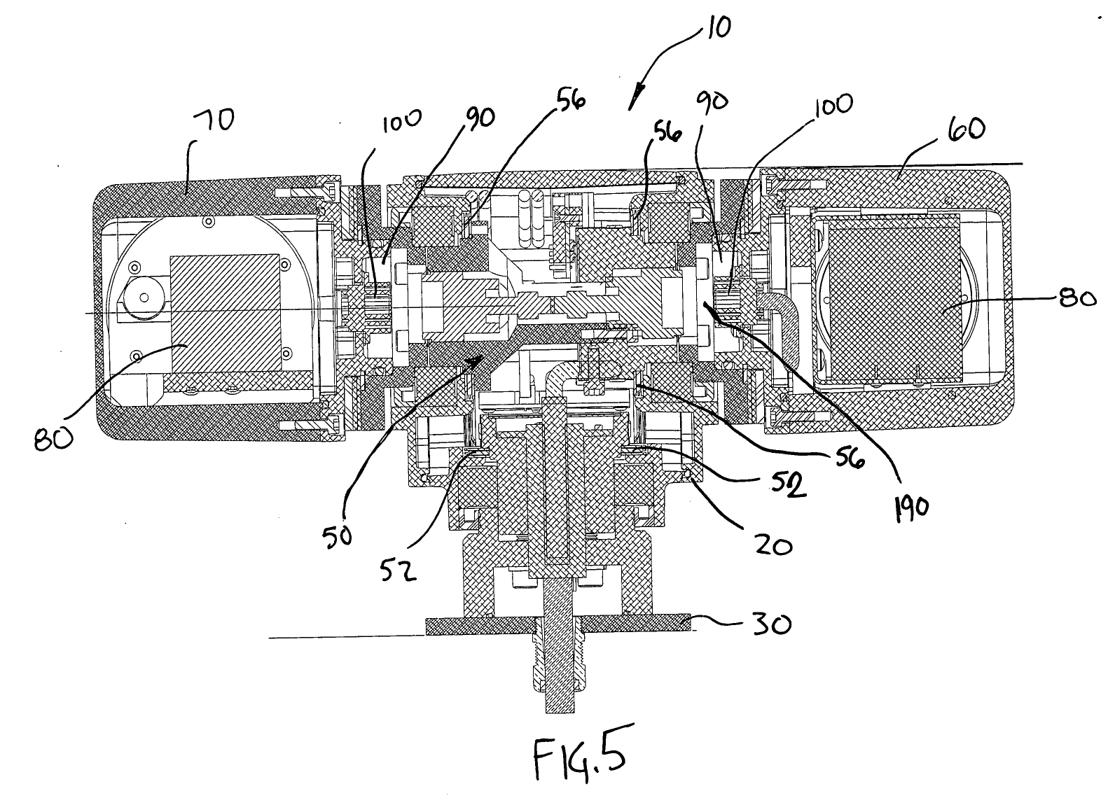

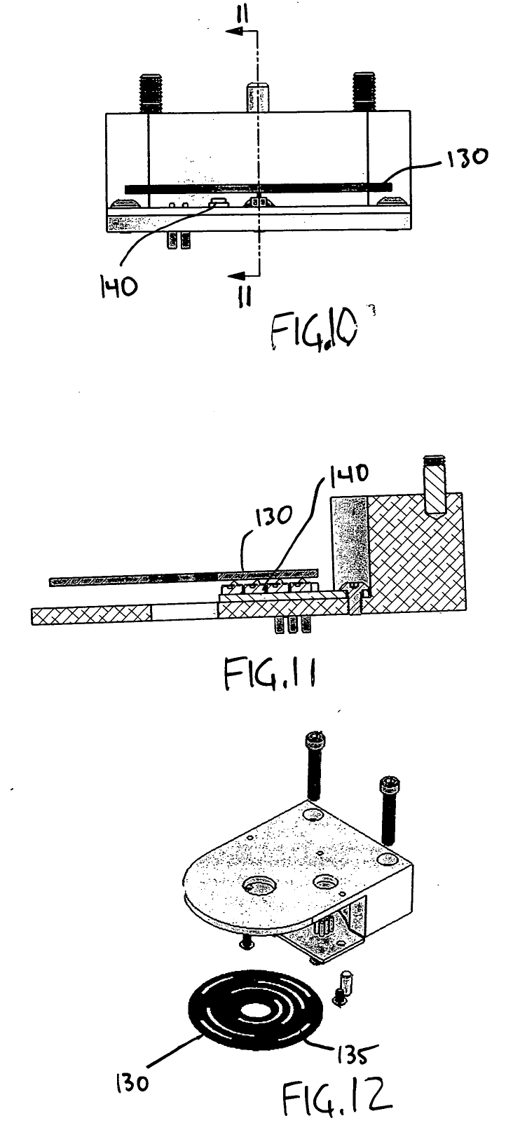

According to a preferred embodiment of this invention, a positioning device 10, such as a pan & tilt device having a range of motion around a horizontal axis and a range of motion around a vertical axis, is adaptable for use in connection with any number of accessories or components. Accessories may include weapon systems, such as rockets and guns, surveillance systems, such as cameras, and positioning and/or guidance systems, such as lasers. FIGS. 1-12 show various features and/or preferred embodiments of the subject invention.

As best shown in FIGS. 1-5, the positioning device 10 preferably includes a housing 20 having a mounting base 30. The housing 20 is preferably constructed of structural materials that provide maximum torsional rigidity. In addition, the housing 20 is preferably powder-coated and corrosion and weather resistant. In particular, the housing 20 is preferably capable of withstanding wet and otherwise corrosive environments; high (+165 degrees F.) and/or low (−30 degrees F.) temperature environments; may operate in high winds (155+ mph); high humidity and/or any other possible environment suitable for the positioning device 10 such as disclosed herein. The housing 20 may include one or more sidewalls 35 which are sealed to and removably attached to the housing 20 to facilitate access and/or adjustment to the mechanical internals, described in detail below.

As shown in FIGS. 1, 4 and 5 the mounting base 30 is positioned outside of the housing 20 and is operatively connected to the mechanical internals of the positioning device 10. The mounting base 30 preferably permits attachment of the pan & tilt device to a fixed surface, such as a wall, mount, stand or a vehicle.

The positioning device 10 according to a preferred embodiment of this invention further includes a drivetrain 50 within the housing 20, the drivetrain 50 preferably configured to rotate the housing 20 around a first axis, for instance a vertical axis.

As shown in FIGS. 1-5, one or more removable mounts 60, 70 are positioned with respect to the housing 20. Removable mounts 60, 70 are preferably configured to rotate about a second axis, for instance a horizontal axis, that is preferably perpendicular to the first axis. As such, the drivetrain 50 is preferably further configured to enable rotation of the removable mounts 60, 70 relative to the housing 20 (“pan”) and around the second axis (“tilt”).

The removable mounts 60, 70 according to a preferred embodiment of this invention may include a single removable mount 60 and/or a second removable mount 70. As used herein, the term “removable mount” may include a desirable number of one or more mounts that are operable relative to the positioning device 10 as described herein.

Each removable mount 60, 70 further includes an accessory 80 positioned on or within the removable mount 60, 70, such as shown in FIG. 3. As described above, the accessory 80 may include any number of devices, however, as generally described herein, the accessory 80 comprises a camera. Accordingly, in a positioning device 10 having multiple removable mounts 60, 70, a first camera may be positioned in or on the first removable mount 60 and a second camera may be positioned in or on the second removable mount 70. Each camera in this described arrangement may have unique properties, such as a standard video camera and an infra-red camera or a video camera and a stop action camera. Likewise, the first removable mount 60 may include a camera and the second removable mount 70 may include a positioning system or thermal imaging system. In this manner, positioning device 10 may be used to accomplish multiple tasks simultaneously including surveillance, positioning, defense and/or any other suitable use for a positioning device 10.

As shown in the drawings, each removable mount 60, 70 is generally configured in a similar manner. However, each removable mount 60, 70 may include a different structure to accommodate different accessories, for instance, a standard camera on the first removable mount 60 and an infra-red camera on the second removable mount 70.

As best shown in FIG. 3, according to one preferred embodiment of this invention having two removable mounts 60, 70, an adjustment means 150 is preferably positioned relative to the first removable mount 60 and/or the second removable mount 70 to skew the second removable mount 70 relative to the first removable mount 60. Specifically, the adjustment means 150 may be a spherical washer mounted relative to a plate, a screw or a similar component for skewing a view angle of a camera in the second removable mount 70 relative to a camera in the first removable mount 60 (or vice-versa). In one preferred embodiment, the second removable mount 70 is preferably a slave to the first removable mount 60 and, as such, all movement of the second camera follows the movement of the first camera. The adjustment means 150 thereby permits the second camera to include the same field of vision as the first camera if such common field of vision is desired.

According to a preferred embodiment of this invention, each removable mount 60, 70 further includes an interface 85 that permits plug and play interaction of the accessory 80 with the housing 20. The interface 85 preferably includes internal encoding for one or more unique accessories 80, such as cameras, that may be used in connection with the positioning device 10.

The accessory 80 is preferably additionally in communication with the drivetrain 50 to permit movement, control and/or powering of the accessory 80 through the positioning device 10. Such communication is described in more detail below.

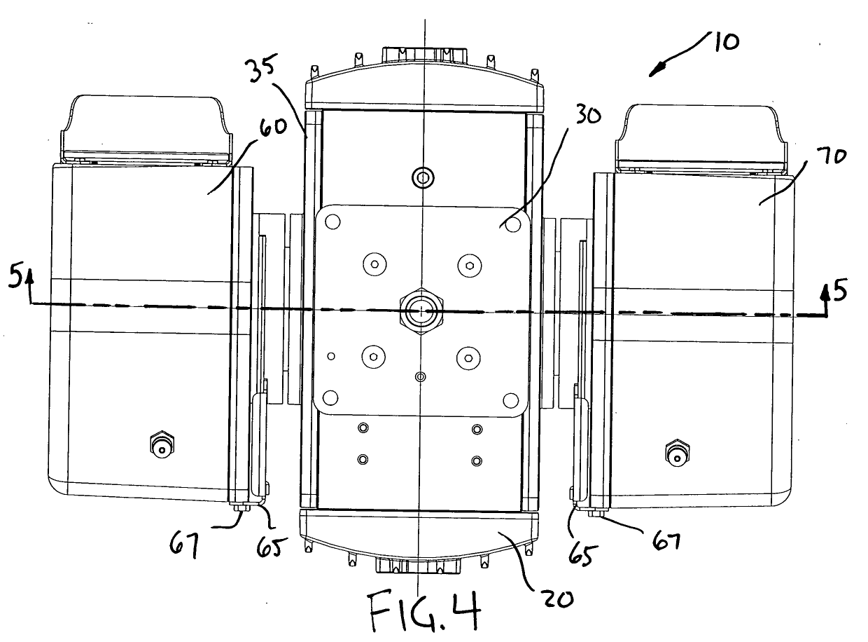

The removable mounts 60, 70 are preferably readily removable from the housing 20 for efficient replacement and/or repair. According to a preferred embodiment of this invention, best shown in FIGS. 4 and 6-8, a release 65 is used to join the removable mount 60 to the housing 20. The release 65 is preferably slidable with respect to the removable mount 60 to permit the unlatching of the removable mount 60 from the housing 20 and, thereby, the removal of the removable mount 60 from the housing 20. Specifically, the release 65 preferably comprises a blade release having a surface that extends in a configuration permitting a user to grasp and slide the release 65 relative to the housing 20.

Likewise, the removable mount 60 may be reinserted into the housing 20 and then reattached using the release 65. A locking screw 67 may be engaged between the release 65 and the removable mount 60 to maintain and ensure the connection between the removable mount 60 and the housing 20. Like the release 65, the locking screw 67 is preferably removable without the use of tools.

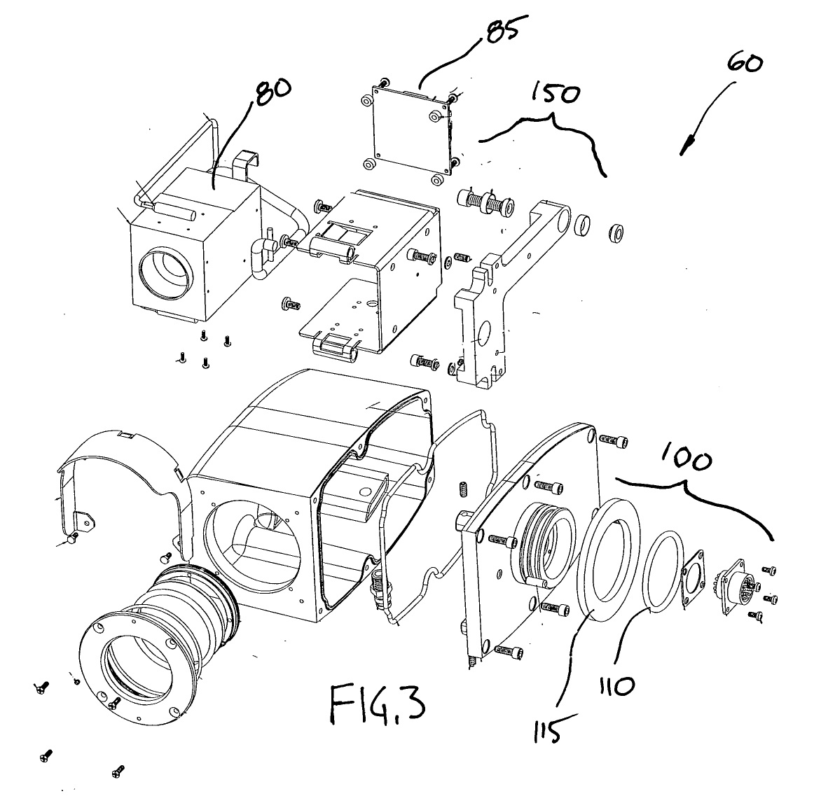

In addition, and as shown in FIGS. 2, 3, 5 and 8, housing 20 preferably further includes a socket 90 engageable with a corresponding removable mount 60, 70. Socket 90 preferably enables both mechanical and electrical communication between the removable mount 60, 70 and the housing 20. According to one preferred embodiment of the invention, each removable mount 60 includes a corresponding plug 100 that interfaces with socket 90.

As shown in FIGS. 2 and 3, the removable mount 60 may include the plug 100 for connecting with the housing 20. The removable mount 60 may further include a suitable o-ring 110 and a seal 115 for creating a sealing engagement between the removable mount 60 and the housing 20. In addition, plug 100 may include a biasing means (not shown) for creating a positive and assured engagement between the removable mount 60 and the housing 20.

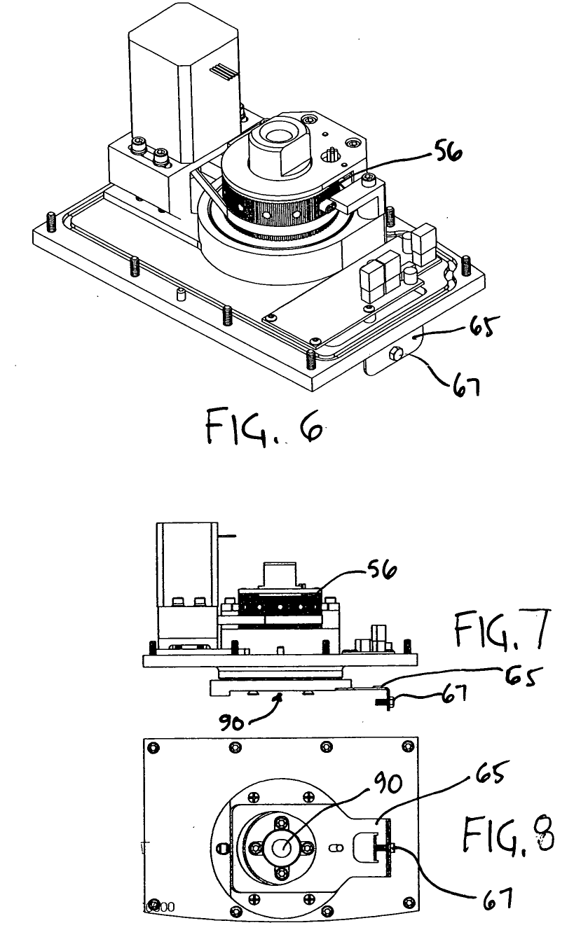

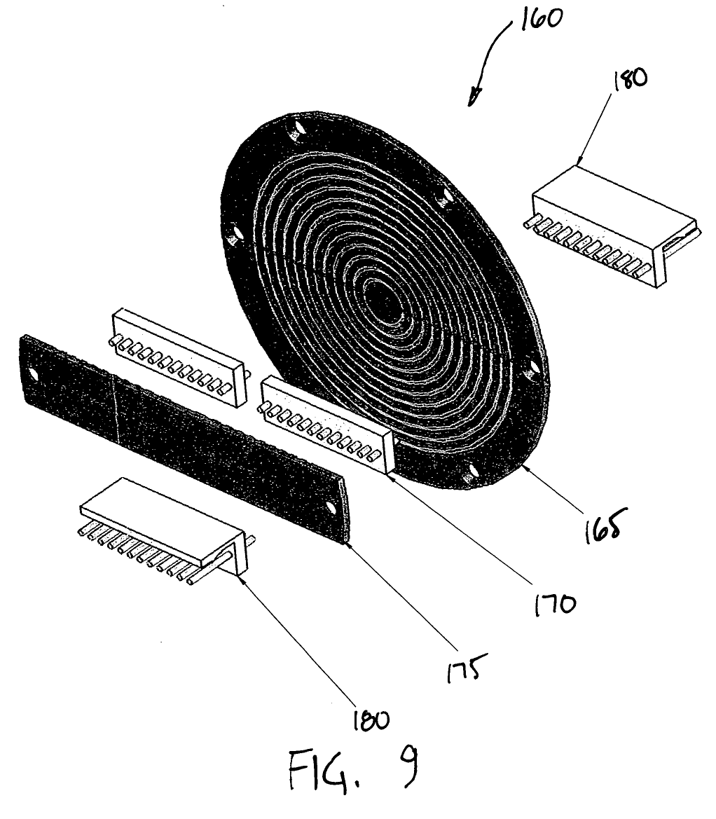

FIG. 9 shows one preferred embodiment of maintaining electrical contact between the removable mount 60, the corresponding accessory 80 and the remainder of the positioning device 10. As shown in FIG. 8, a slip ring assembly 160 may be positioned between the housing 20 and the removable mount 60. Specifically, a stator 165 may be positioned in one of the housing 20 or the removable mount 60 and a corresponding wiper 170 may be positioned in a rotor 175 positioned in one of the corresponding removable mount 60 or housing 20. Connectors 180 may then extend from the slip ring assembly 160 to maintain power to the removable mount 60 following replacement.

According to a preferred embodiment of this invention, positioning device 10 further includes a controller (not shown) in communication with the drivetrain 50. The controller is preferably used to control, program and/or operate the positioning device 10, specifically the drivetrain 50 within the positioning device 10.

Specifically, the housing 20 preferably includes a universal bus 190 that facilitates the operation of the positioning device 10 with a variety of accessories 80, specifically, with a variety of cameras. The universal bus 190 preferably connects the controller with the drivetrain 50 and the interface 85 and/or the accessory 80 to permit operation of various motor drivers include a pan motor driver and a tilt motor driver for the operation of the positioning device 10 and a zoom motor driver and a focus motor driver for adaptive operation of the accessory 80, specifically a camera.

As described, the controller, interface 85 and universal bus 190 use a communication method that allows direct connection and control of any number of brands and/or models of cameras and/or devices. Unique “commands” (instructions) in the positioning device 20 “protocol” (menu of commands or “internal operation protocol”) may be used in combination with the commands for the accessory 80, that allows the positioning device 10 to identify and separate the instructions for the accessory 80 and redirect them directly to the accessory 80. As a result, the protocol for the particular accessory 80 is appended or otherwise connected with the internal operation protocol of the positioning device 10 and then transmitted in a form readable by both the accessory 80 and the positioning device 10.

For example, in a particular application, such as a security camera on a street corner that requires a particular Hitachi camera, the Hitachi camera is mounted on the positioning device 10 and connected to the controller. When the operator wishes to control a specific function of the positioning device 10 such as pan, the “pan command” from the internal operation protocol is sent to positioning device 10. When the operator wishes to control a specific camera function such as shutter speed, the “shutter speed command” from the accessory operation protocol is appended with the internal operation protocol, and sent to the positioning device 10. The positioning device 10, specifically the universal bus 190, recognizes and redirects the command, minus the internal operation protocol, directly to the Hitachi camera. Therefore, any accessory 80 can be used without a change to the electronics within the positioning device 10. One benefit of such operation is that an accessory 80 operating with serial connectivity, that is not normally individually addressable may be made to be individually addressable as if operating with RS485 connectivity.

According to a preferred embodiment of this invention, such as shown in FIG. 10-12, a sensor disk 130 is positioned within the housing 20. The sensor disk 130 preferably includes a plurality of calibration marks 135. Further, an optical sensor 140 is positioned in communication with the sensor disk 130 and the controller and permits the removable mount 60 to be calibrated with respect to the housing 20. In one preferred embodiment of this invention, the plurality of calibration marks 135 forms a reflected binary code. The removable mount 60 may be calibrated with respect to the housing 20 at more than ten positions of the removable mount 60 relative to the housing 20.

The mechanical internals of the positioning device 10 are best shown according to various preferred embodiments of the invention in FIGS. 5-12 and preferably include a drivetrain 50 positioned within the housing 20. The drivetrain 50 is preferably connected and positioned to rotate the housing 20 relative to the mounting base 30 and also the removable mounts 60, 70 relative to the housing 20.

The drivetrain 50 preferably includes one or more pan drives 52 for providing a panning motion of the positioning device 10 about a first axis and one or more tilt drives 56 for providing a tilting motion of the positioning device 10 about a second axis, perpendicular to the first axis. Pan drives 52 and/or tilt drives 56 may include a belt and pulley arrangement, a set of interactive gears, wormgears and/or any other suitable arrangement that permits the positioning device 10 to move in a pan direction and/or a tilt direction.

The positioning device 10 is described herein as having a pan drive 52 and a tilt drive 56, specifically for application in a pan & tilt device, however, this invention is not limited to a positioning device 10 having both a pan drive 50 and a tilt drive 100. The principles of the described invention work equally well for a positioning device 10 having only a pan drive 50, only a tilt drive 100 and/or any other belt, pulley, gear or combination thereof. In such a manner, the positioning device 10, particularly the mounting base 30 of the positioning device 10, can be located in a desired pan and/or tilt position.

Drivetrain 50 preferably utilizes 0.9 degree stepper motors with a 16:1 microstepping drive. Such stepper motors may comprise and/or drive associated pan drive 52 and/or tilt drives 56, respectively. The belt pulley ratio in such drives is preferably 16:90 resulting in 0.01 degree rotation in both pan and tilt per microstep. Every microstep input to the drivetrain 50 of the housing 20 therefore preferably results in movement of exactly 0.01 degree. The drivetrain 50 therefore achieves incremental steps of 0.01 degree per microstep input. Because there are preferably no encoders, each microstep is counted to identify 90 degrees=9,000 microsteps. In the pan direction, according to one preferred embodiment of this invention, there are seventeen transitions, and thus sixteen identifiable sectors, each permitting re-calibration of the positioning device 10. In tilt, according to one preferred embodiment of this invention, there are three transitions with four identifiable sectors, each permitting re-calibration of the positioning device. In this manner, the positioning device 10 may be re-calibrated on the fly during realtime operation of the positioning device 10.

The positioning device 10 includes a housing 20 that preferably permits continuous rotation capabilities and 180 degree (preferably ±90 degrees) tilt rotation capabilities. Continuous rotation is preferably accomplished using electrical contact “slip rings.” In addition, the housing 20 includes internal motors and/or gearing that permit 0 degree to 100 degree per second (variable) pan speed or faster. The housing 20 will also preferably permit tilt speed up to 0 degree to 60 degree per second (variable) tilt speed or faster. Movement of the positioning device is preferably repeatable to within up to approximately 0.10 degrees and more preferably within approximately 0.05 degrees. According to a preferred embodiment of this invention, the combination of mechanicals and electronics in positioning device 10 permit a drive resolution of 0.01 degrees and a corresponding electronic readout capability of 0.01 degrees.

The positioning device 10 preferably includes internal mechanicals that may accommodate hard limits and/or soft limits for limiting a fixed range of motion for the tilt of the positioning device 10. Such limits may be useful in particular applications requiring that the component and/or positioning device 10 be limited to a particular range of motion, i.e. because of physical restrictions of the mounting environment. For positioning devices configured with slip rings and thus a 360 degree range of motion, the trip rings and, for pan rotation, limit switches are unnecessary.

The housing 20 is preferably constructed using fasteners and concealed wiring and connection points. Traditionally, one or more wires must extend from the positioning device 10, including at least communication and AC or DC power. According to a preferred embodiment of this invention having an optimal mount, these wires extend outside of the positioning device 10 or the mounting environment.

The positioning device 10 according to a preferred embodiment of this invention may include an internal heater for operation at low temperatures. In one preferred embodiment of this invention, the internal motors of the housing 20 may act to heat the internals of the housing 20. Additionally, removable mounts 60, 70 may include internal heaters for operation at low temperatures. In addition, or in the alternative, the positioning device may include a fan/blower for operation in humid, wet and/or high temperature environments.

While in the foregoing specification this invention has been described in relation to certain preferred embodiments thereof, and many details have been set forth for purpose of illustration, it will be apparent to those skilled in the art that the method and apparatus according to this invention are susceptible to additional embodiments and that certain of the details described herein can be varied considerably without departing from the basic principles of the invention.

We claim:

1. A pan & tilt device comprising:
a housing;
a drivetrain within the housing, the drivetrain configured to rotate the housing around a first axis;
a removable mount positioned on the housing;
an accessory positioned on the removable mount, the accessory in communication with the drivetrain; and
a release joining the removable mount to the housing, the release slidable with respect to the removable mount.

2. The pan & tilt device of claim 1 wherein the accessory comprises a camera moveable about a second axis perpendicular to the first axis.

3. The pan & tilt device of claim 1 further comprising:
a socket positioned within the housing, the removable mount engageable with the socket to provide mechanical and electrical communication between the removable mount and the housing.

4. The pan & tilt device of claim 1 further comprising:
a locking screw positioned within the release.

5. The pan & tilt device of claim 1 wherein the release comprises a blade release slideable with respect to the removable mount.

6. The pan & tilt device of claim 1 further comprising:
a controller;
a sensor disk positioned within the housing, the sensor disk including a plurality of calibration marks;
an optical sensor positioned in communication with the sensor disk and the controller and permitting the removable mount to be calibrated with respect to the housing.

7. The pan & tilt device of claim 6 wherein the plurality of calibration marks forms a reflected binary code.

8. The pan & tilt device of claim 6 wherein the removable mount may be calibrated with respect to the housing at more than ten positions of the removable mount relative to the housing.

9. The pan & tilt device of claim 1 further comprising:
a second removable mount positioned opposite the removable mount, the second removable mount rotatable about the second axis; and
a second accessory positioned on the second removable mount.

10. The pan & tilt device of claim 1 further comprising:
an adjustment means positioned between the removable mount and the second removable mount to skew the second removable mount relative to the removable mount.

11. A pan & tilt device comprising:
a housing;
a drivetrain within the housing, the drivetrain configured to rotate the housing around a first axis;
a first removable mount positioned on the housing;
a first camera positioned on the first removable mount, the first camera in mechanical communication with the drivetrain;
a second removable mount positioned on the housing;
a second camera positioned on the second removable mount, the second camera in mechanical communication with the first camera; and
an adjustment means positioned between the first removable mount and the second removable mount to skew the second camera relative to the first camera.

12. The pan & tilt device of claim 11 further comprising:
a controller;
a sensor disk positioned within the housing, the sensor disk including a plurality of calibration marks;
an optical sensor positioned in communication with the sensor disk and the controller and permitting the first removable mount to be calibrated with respect to the housing.

13. The pan & tilt device of claim 11 further comprising:
a release joining the first removable mount to the housing, the release slidable with respect to the first removable mount.

14. The pan & tilt device of claim 11 wherein the first camera and the second camera are moveable around a second axis perpendicular to the first axis.

15. The pan & tilt device of claim 14 wherein the second camera moves with the first camera.

16. The pan & tilt device of claim 11 wherein the drivetrain is recalibrated on the fly during operation of the pan & tilt device.

17. A surveillance camera comprising:
a housing moveable about a first axis;
a removable mount positioned on the housing, the removable mount moveable about a second axis perpendicular to the first axis;
a camera positioned on the removable mount;
a socket positioned within the housing, the removable mount engageable with the socket to provide mechanical and electrical communication between the removable mount, the camera and the housing; and
a controller in communication with the housing, the controller capable of calibrating the removable mount relative to the housing.

18. The surveillance camera of claim 17 further comprising:
a sensor disk positioned within the housing, the sensor disk including a plurality of calibration marks;
an optical sensor positioned in communication with the sensor disk and the controller and permitting the first removable mount to be calibrated with respect to the housing.

19. The surveillance camera of claim 17 further comprising:
a release positioned between the removable mount and the housing, the release slideable relative to the housing for separating the removable mount relative to the housing.

20. The surveillance camera of claim 17 further comprising:
a second removable mount positioned on an opposite side of the housing as the removable mount, the second removable mount mechanically connected with respect to the removable mount; and
a second camera positioned on the second removable mount.

21. The surveillance camera of claim 20 further comprising:
an adjustment means for skewing the second camera relative to the camera.

22. A pan & tilt device comprising:
a housing;
a drivetrain within the housing, the drivetrain configured to rotate the housing around a first axis;
a first removable mount positioned on the housing;
a first camera positioned on the first removable mount, the first camera in mechanical communication with the drivetrain; and
a socket positioned within the housing, the removable mount engageable with the socket to provide mechanical and electrical communication between the removable mount and the housing.

23. The pan & tilt device of claim 22 further comprising:
a second removable mount positioned on the housing;
a second camera positioned on the second removable mount, the second camera in mechanical communication with the first camera.

24. The pan & tilt device of claim 22 wherein the drivetrain and the first removable mount are configured to permit movement of the first camera in 0.01 degrees of resolution.

25. The pan & tilt device of claim 24 wherein the movement of the first camera is displayable in 0.01 degree increments.
